(19) United States
(12) Patent Application Publication
(10) Pub. No.: US 2015/0161833 A1
(43) Pub. Date: Jun. 11, 2015

(54) INTELLIGENT ACCESS CONTROL FOR AMUSEMENT PARK RIDES TO SUPPORT MAINTENANCE AND TESTING

(71) Applicant: Disney Enterprises, Inc., Burbank, CA (US)

(72) Inventor: John Douglas Smith, Lake Buena Vista, FL (US)

(73) Assignee: Disney Enterprises, Inc., Burbank, CA (US)

(21) Appl. No.: 14/097,434

(22) Filed: Dec. 5, 2013

(51) Int. Cl. G07C 9/00

(52) U.S. Cl. CPC G07C 9/00111

(57) ABSTRACT

A method for controlling an amusement park ride to provide safe access for maintenance and testing. The method includes first determining a location of an access control key and then second determining whether the determined location is within a control space. The method includes, when the access control key is in the control space, operating a machine of the park ride in a first operating mode. When outside the control space, the method includes operating the machine in a second operating mode. The second operating mode may include disabling the machine. The method may further include, after the operating the machine in the second operating mode, repeating the first determining of the location of the access control key, third determining whether the determined location is within a predefined safe space, and, when the access control key is within the predefined safe space operating the machine in a third operating mode.

### BACKGROUND

1. Field of the Description

The present description relates, in general, to methods and systems to for controlling operations and access to operating machinery, and, more particularly, to methods and systems for controlling operations of an amusement park ride, such as a roller coaster or a themed ride, to facilitate safe maintenance and testing of the ride.

2. Relevant Background.

With any amusement park ride, safety is one of the most important design and operating parameters. More specifically, the ride and its control systems must be designed to strictly control access to areas or spaces on or near the ride where machines (such as drive mechanisms including drive shafts, pulleys, belts, chains, and the like) or other components (such as ride vehicles rolling on tracks or along ride paths in trackless rides) may be in motion to prevent injury. For example, a roller coaster should be designed such that personnel access is controlled (blocked) to areas or spaces associated with a launch mechanism and also to spaces about the ride's track to avoid injury to ride operators, maintenance personnel, observers, and others.

Ride access control is a particular issue when a ride operator needs to perform maintenance of an existing ride and when a ride designer/builder needs to perform testing or test rides for a new or modified ride. To maintain a ride, maintenance personnel need to have access to spaces on or near machines or components that may be in motion and cause injury if the ride were to operate normally while the worker is still in the space or working on the machine. Likewise, a ride designer may wish to observe and monitor a ride and its moving components from various viewpoints or locations while the ride is operating as intended or designed, but access control has to be properly implemented to avoid injury to the monitoring personnel, which typically has limited the observation points that could be used during test rides or testing.

In the amusement park industry, it is a common practice to have a standard operating or maintenance procedure that governs access to potentially dangerous machine areas or that controls the operation of the machine when an access has been made by any personnel to a potentially unsafe area or space. These procedures typically involve providing some system for manually limiting or governing access to the machine or potentially unsafe areas or manually operating the machine in a particular way to facilitate maintenance or testing access.

An exemplary manual access control process may use name tags and numbered plaques that must be in a particular, pre-assigned place before the machine is started or operated. In many cases, special procedures are created to allow a person into a restricted area when a machine is running. For example, these special procedures may involve may require redundant “spotters” or additional observers during maintenance to watch unsafe areas and may involve complex and rigorous communications (or communication protocols) to avoid risks of injury. If these procedures are not followed or if there is an unexpected repositioning of a person in a machine area, the resulting injuries may be very serious and are, of course, unacceptable to operators of an amusement park ride.

These special procedures can be quite cumbersome and hard to follow such that they can make routine maintenance and testing tasks unduly difficult to complete in a timely. Additionally, these control procedures are expensive to implement as they often require a number of added workers to be involved simply as spotters and messengers/communicators. Hence, there remains a need for new access control systems and methods. Preferably, the new systems and methods would be more automated to require fewer personnel to perform and would be more automated to limit a potential for human error and also lessen the workload associated with performing maintenance and testing or test rides for amusement park, theme, or attraction rides (“park rides” or simply “rides”).

### SUMMARY

The present description teaches an intelligent access control method and system that is adapted to provide more automated control over access to work spaces near or surrounding a park ride and its operating machinery (or “machines”). More accurately, the access control method is useful for determining the locations of personnel, such as maintenance workers and test ride monitors, in spaces or predetermined proximities to particular machines or portions of a park ride and to respond by operating or controlling the ride to operate in one of several operating states or modes that assure the safety of the monitored personnel.

In one implementation, the control system utilizes a set or predefined number of smart tags or keys that are machine readable (e.g., a radio-frequency identification (RFID) tag or the like). The control method then may involve determining the location of the predefined number of smart tags or keys that have been provided to workers/personnel by processing reader signals. Based on these determined locations, the control method may further include a step of determining that all the smart tags or keys are in or near an approved work space (or safe space or approved location) prior to allowing a particular machine motion.

In normal or standard operating mode, the keys or tags may be hung or positioned near a control reader that provides its output to a ride controller, and the ride controller running an access control program or module may require that all tags be present or in their expected location before allowing normal machine operation. During access-required work, the keys or tags may be attached to, worn, or carried by workers or ride-accessing personnel and removed from the control reader space (or normal operating tag/key location or space). The ride controller would, based on this new location outside the control reader space, disable the entire park ride or certain machines from starting or performing normal operations until the tags/keys are returned to their standard location in the control reader space (e.g., machine not operable when a worker is in a machine room or in an otherwise potentially unsafe location near the ride).

The control system may include additional readers (or work space readers) in spaces near the ride and its machines that have been predetermined to be safe locations (such as a space within a machine room that is at an adequate distance from moving parts). The ride controller may operate to determine the workers or ride-accessing personnel are in a safe location and enable normal ride operations to again proceed or to enable a number of maintenance or testing activities (access-required activities) to be performed with partial or predefined operations of the ride or subsets of its machines (e.g., control the ride to perform a test ride that may involve a subset of normal ride operations).

The access control module run by the ride controller may be adapted to automatically select a set of ride controls/programs to control the ride in a predefined manner based on the location of the ride-accessing personnel. For example, the ride-accessing personnel may be determined to have moved into a first safe space near the ride such as in a first machine room, and the ride controller may reconfigure the machine operating parameters (a machine in the first machine room) or ride control parameters to facilitate maintenance and/or testing. Then, the ride controller may determine the ride-accessing personnel has moved out of the first safe space and into a second safe space. The access control module may respond by disabling operations as the person (and their key) move out of the first safe space and then to reconfigure the machine operating or ride control parameters to facilitate a second set of maintenance or testing of the park ride. In this manner, the access control module (or access control method performed by the ride controller) is adapted to automatically react if a tag or key is moved from a safe location to an unsafe location while the ride or a machine(s) is operating and then is again moved back into a safe location (the same or a differing safe location/space).

More particularly, a method is provided for controlling an amusement or theme park ride to provide safe access for maintenance and testing. The method includes first determining a location of an access control key and then second determining whether the determined location is within a control space. Further, the method includes when the access control key is in the control space as indicated by the second determining, operating a machine of the park ride in a first operating mode. Then, when the access control key is outside the control space as indicated by the second comparing, operating the machine of the park ride in a second operating mode differing from the first operating mode.

In some cases, the second operating mode includes disabling operating of the machine. In such cases, the method may further include, after the operating the machine in the second operating mode, repeating the first determining of the location of the access control key, third determining whether the determined location is within a predefined safe space in the park ride, and when the access control key is within the predefined safe space operating the machine of the park ride in a third operating mode including reconfiguring operating parameters of the machine relative to the first operating mode.

The method may be implemented with the access control key being a radio-frequency identification (RFID) tag, and then the determining of the location of the access control key may involve reading the RFID tag to retrieve an ID for the access control key with an RFID reader positioned in the control space. Further, the second determining of the method may include identifying the RFID tag reader as one in the control space and identifying the ID as being associated with the access control key.

In some implementations, the method may include, when the access control key is outside the control space, third determining whether the determined location is within a safe space defined relative to the machine. In such cases, the first operating mode may include operating the machine according to a first set of operating parameters, and the second operating mode may include operating the machine according to a second set of operating parameters differing at least partially from the first set of operating parameters.

### BRIEF DESCRIPTION OF THE DRAWINGS

FIG. 1 is a functional block diagram of a ride system of one embodiment of the description with a ride controller and otherwise configured to perform the intelligent ride access control method described herein;

FIG. 2 is a functional block diagram of the ride system of FIG. 1 at a second time when a worker such as a maintenance worker or ride tester has removed one of the smart keys from the control space;

FIG. 3 is a functional block diagram of the ride system of FIG. 1 at a third time when the worker has moved into a predefined safe space in a first machine room (or space defined relative to one or more machines of the park ride);

FIG. 4 is a functional block diagram of the ride system of FIG. 1 at a fourth time when the worker or ride-accessing person has moved into a predefined safe space relative to a ride track such as for testing a ride including observing movement or operations of a ride vehicle on a ride track; and

FIG. 5 is a flow diagram showing steps that may be carried out by the ride system of FIG. 1 during implementation of a ride access control method of the present description.

### DETAILED DESCRIPTION

The present description is directed toward methods and systems for intelligently and in an automated manner controlling personnel access to an amusement park, theme, attraction, or other ride, e.g., to machine rooms containing drive mechanisms, to areas near a ride track where a vehicle and its associated equipment may pass, and the like. The access control method and system is designed to address the problem associated with attempting to safely perform maintenance or perform testing (e.g., a test ride for a new or modified ride). Maintenance and testing may require or at least benefit from allowing a ride or its machinery/machines to operate in full or maintenance/testing modes while workers are in a number of locations that have been predetermined to be safe.

Briefly, to this end, the access control system may include a number of tags or keys that can be coded to the ride system, and one or more readers may read an identification (ID) from these keys to allow a ride controller to determine the locations of all the keys relative to the ride. The ride controller (e.g., a processor running an access control module) may act to compare these determined key locations to determine what operating modes or states of the ride are safe and acceptable. For example, all of the keys may be positioned in a space (control reader space) where they can be read by a first (control) tag reader, which can signal the IDs of all the keys/tags to the ride controller for determination/verification the keys are all in the control space (or in known locations assigned for standard/normal ride operations). The controller may, in response, enable or control the ride to operate in a first or normal operating state (or mode).

However, when a worker moves one of these keys/tags out of the range of this first tag reader (out of the control space or assigned location(s)), the ride controller may respond by shutting down the ride (operating the ride in a second state). Next, the worker may move the key (which they may be wearing into a safe space in either a machine room (or space about a machine) or along a length of a ride track over which passenger vehicles will travel. A tag reader(s) associated with these safe spaces reads the key and signals the ride controller. The ride controller determines the current location to determine that all keys are in safe locations, and, based on movement of one (or more) key into a new safe space, the ride controller may select a new maintenance/testing ride operating mode for the ride and enable such operations (or send control signals to the machines of the ride to operate the ride in such an additional safe operating mode (e.g., energize all portions of ride except those in the safe zone in which the worker is located)).

In some cases, two (or more) workers may have removed keys/tags from the control space and be in remote locations, and the ride controller may select an operating mode that suits the present location of these workers in the same or differing predefined safe spaces/zones (select testing/maintenance operating mode based on combination of locations of keys/tags) or one or more in an unsafe location (shut ride down). The change in operating mode may involve shutting down the entire ride when a worker/ride-accessing person is in an unsafe location, locally disabling pieces of equipment/machines near a ride-accessing person's current location (or even divert vehicles away from sections of track being worked on by worker or the like), globally changing the way the park ride or its machines work to be safe for persons in certain locations, and reconfiguring the ride to operate in a test mode that differs from normal/standard operations for the ride.

In some embodiments, the ride controller may provide control signals to the machines (or access control devices associates with such machines) to communicate with the worker in a safe zone or space near such machines. For example, the ride controller may determine that a worker or ride-accessing person has moved into a safe space or zone in a machine room near one or more machines. The ride controller may illuminate a light, provide an audio output, or operate a user interface on a screen to notify the worker that they are presently in a safe space and that the ride system has read their key (which may then result in a reconfiguration of operating parameters and operating the ride and the nearby machine in a testing/maintenance mode). Alternatively, the worker or ride-accessing person may have to perform an additional step to cause the ride controller to initiate control over the machines/ride in a particular testing/maintenance mode (e.g., insert another key, interact with the user interface of a touch screen, activate a switch in the safe area of the machine room, and the like).

There are some basic differences in ways the present system and method may be implemented and processes taught and used in the past. Prior techniques to move a machine to a safe state involved the presence of a key or tag. They did not make teach enabling the machine only when all keys or tags are present in one location or another. The presently described systems/methods provide a few basic functions that can be described in terms often used in ride design and operation. The first is “Ride Access Control,” which means that all the keys or tags must be present at the control booth in order to start the ride in normal operation. This is important because to avoid assuming the area is safe and then relying on the system of sensors to determine when there is a new, unsafe condition based on sensing a tag. This allows one to move from the control booth into the ride space without the possibility of the ride starting since the person has the key or tag required to start; thus, accomplishing a Lock Out Tag Out (LOTO) action.

Further, the system described herein is often designed or configured to put the machine or ride into one of several known states based on intentional actions as opposed to reacting unexpectedly to a new unsafe state as in some prior systems. It may also be important to note that the described system could be accomplished very readily using keys and “ignition switches” and that RFID is just one useful method for providing the location-based key or tag discussed herein. The key may, in some cases, actually provide some benefits over the RFID tag and vice versa

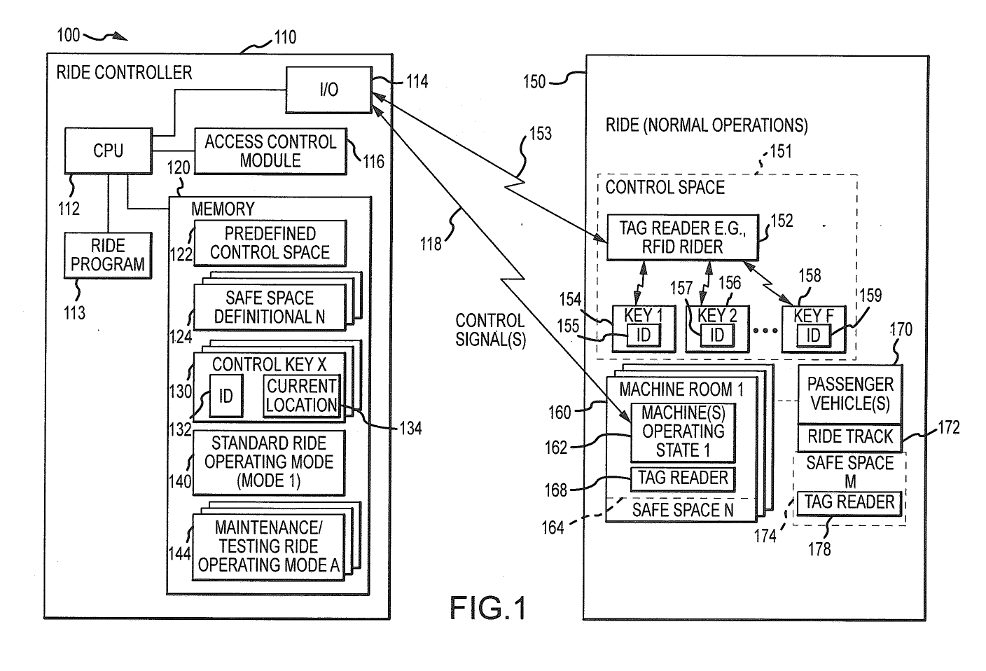

FIG. 1 illustrates a functional block diagram or schematic of a ride system 100 that is adapted to provide intelligent access control to facilitate maintenance and testing of a ride 150. The system 100 includes a ride controller 110 that transmits control signals 118 (in a wireless or wired manner) to a ride 150, e.g., a passenger ride such as a roller coaster, a water ride, a themed ride, or the like with vehicles 170 riding, optionally, on a track 172, to control operations of the ride 150 and its machines 162 (e.g., drive mechanisms for the vehicles 170 and for providing special effects and show features along the ride track 172).

The ride controller 110 may take a variety of forms to practice the invention and to provide the control signals 118 to machines 162 of the ride. As shown, the ride controller 110 includes one or more processors 112 that are adapted to manage input/output devices 114 (e.g., communication transceivers, receivers, keyboards, touchscreens, a mouse, a touch pad, a monitor screen, and so on) for transmitting the control signals 118 and also for receiving data in signals 153 from the tag readers 152, 168, 178 provide in the ride or ride assembly 150.

The processor 112 further manages memory 130 (within the controller 110 or accessible by controller over a network) and executes computer-readable code (or code in computer-readable media) including a ride program 113 that is useful for generating the control signals 118 for machines 162 based on a set of operating parameters. The ride operating parameters are typically defined in a standard ride operating mode (first operating mode) stored in memory 120 and also by one or more maintenance/testing ride operating modes 144 also stored in memory 120.

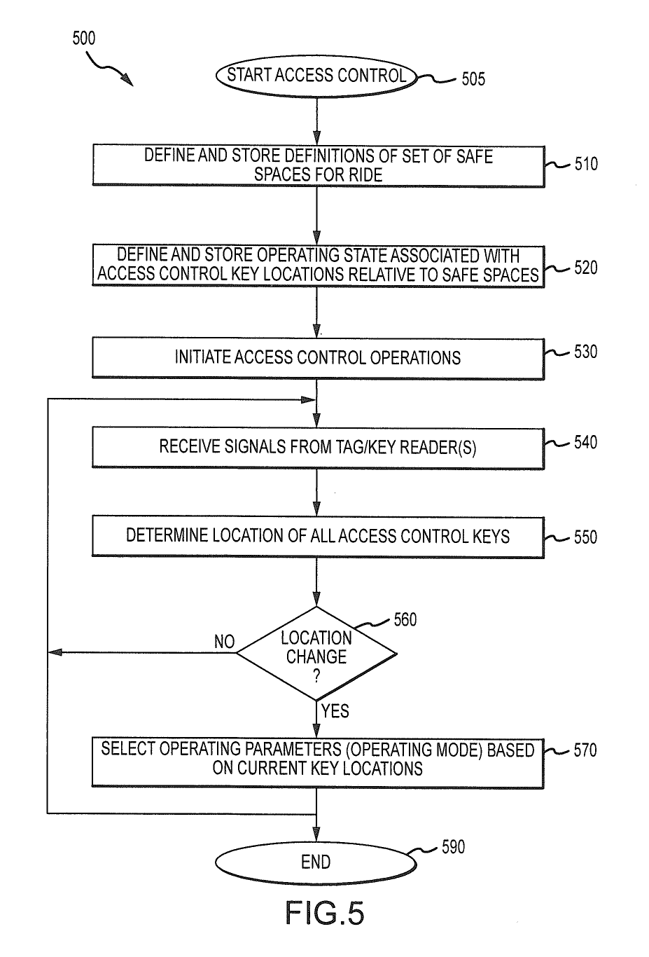

The processor 112 further functions to execute computer-readable code (or code in computer-readable media) defining an access control module 116, which causes the ride controller 110 to perform the ride access control method described herein (see FIG. 5, for example) including issuing differing control signals 118 based on current locations of a number of smart tags or keys 154, 156, 158 within the ride 150 or the ride space. As part of executing the module 116 or facilitating its performance, the memory 120 is used to store a predefined control space or set of locations 122 associated with a control space 151 in or associated with the ride 150. A tag reader 152 is provided in the control space 151 and acts to read a number of access tags or keys 154, 156, 158 including readable ID data 155, 157, 159. For example, each key 154, 156, 158 may take the form of a plastic badge or the like that includes an embedded or attached RFID tag coded with identification information that can be used by the reader 152 to verify the identity and to track the keys 154, 156, and 158 (or ensure the tags/keys 154, 156, 158 are in the space 151). Upon successful reading, the tag reader 152 transmits the ID or read data as shown at 153 to the ride controller 110.

In response to receiving the data 153, the ride controller 110 may use the access control module 116 to determine whether all expected smart tags/keys 154, 156, 158 are within the control space or zone 151. The memory 120 is used to store definitions 130 of all the control or access keys 154, 156, 158 used with the ride 150 including an ID 132 and a determined current location 134 within or proximate to the ride 150. With this in mind, the access control module 116 acts to process the read data 153 to determine that the current location 134 for all of the keys 154, 156, 158 is within the control space 151.

In response, the access control module 116 may communicate to the ride program 113 or other modules within the ride controller 110 that the ride may be operated in its normal operations (as no workers or ride-accessing persons are in unsafe spaces or in alternative safe locations, as discussed below). The ride controller 110 may retrieve operating parameters defined in a standard operating mode (first operating mode) definition 140 available in memory 120 and generate a set of control signals 118 to machines 162 in one or more machine rooms/spaces 160. This may cause a passenger vehicle(s) 170 to be moved along the ride track 172 in a particular pattern and at predefined speeds.

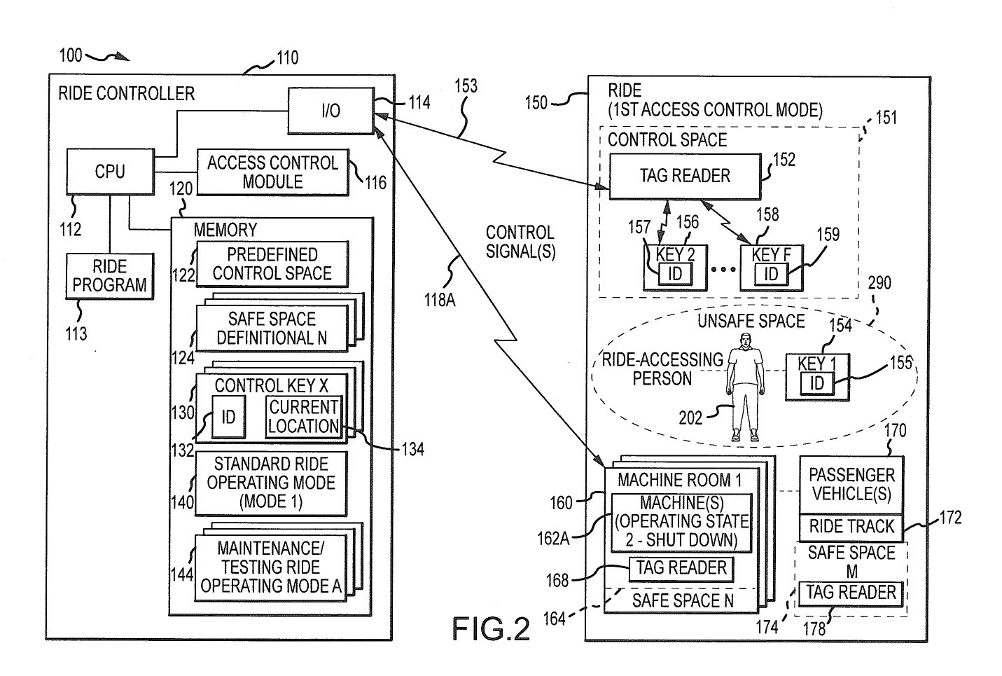

According to some implementations of the access control method, the ride controller 110 acts to shut down or disable the ride 150 or its machines 162 if one or more of the keys 154, 156, 158 is moved out of the control space 151 (e.g., moved from a range of the reader 152 to outside a space that is within the range of the reader 152). This can be seen with reference to FIG. 2 where the ride system 100 is shown with the ride 150 being operated in a first access control mode. As shown, the ride-accessing person 202 is wearing (or otherwise has the key 154 on their person) an access control key 154, and the key 154 and person 202 have moved outside the control space 151 where the reader 152 can read the ID 155 or into an “unsafe” space 290 (e.g., any space not predefined or predetermined to be an acceptable location in the ride 150 for a person during ride operations).

The tag reader 152 continues to send data at 153 to the ride controller 110 on the IDs 157, 159 read from keys 156, 158. The access control module 116 processes this data to determine the current locations (stored at 134 in memory 120) for the two keys 156, 158 as being within the control space 151. However, the location of the key 154 is, in this example, unknown and a null value or unknown location is stored at 134 for the control key file/record 130 having an ID 132 matching the ID 155 of key 154. In other implementations (such as those using or supplemented with GPS or similar technologies or an implementation where tag readers are also provided in potentially unsafe locations/spaces of the ride 150), the current location of key 154 may be known but be determined to be in an unsafe location (e.g., not in a space 151 or spaces 164, 174).

In response to this determination by the access control module 116 (which is communicated to the ride program 113), the controller 110 retrieves a ride operating mode 144, from memory 120, that defines operating parameters for machines 162A when a ride-accessing person 202 is in an unknown and/or unsafe space 290. In FIG. 2, the controller 110 is shown to transmit control signals 118A (differing from signals 118 of FIG. 1) that causes the machine(s) 162A to be operated in a second operating state, which may involve disabling or shutting down the machine 162A to avoid injury to the person 202.

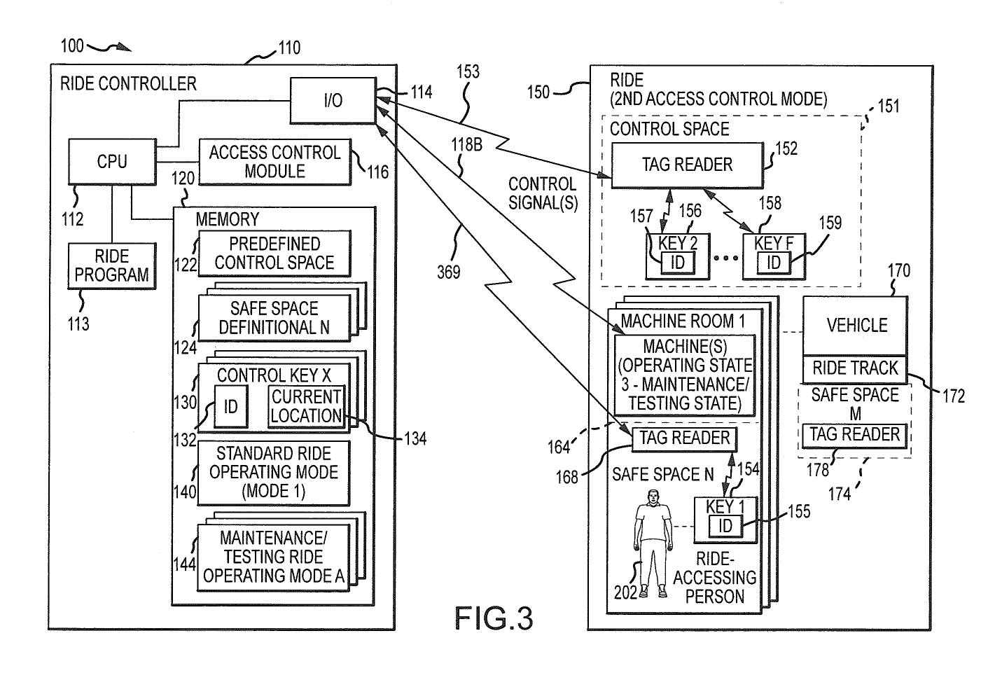

Further, though, the access control module 116 may enable the ride 150 to be operated in a non-standard or testing/maintenance mode (as defined by operating parameters 144 stored in memory 120) when the worker and the key they are wearing/carrying is moved into a predetermined safe space or zone. FIG. 3 illustrates operation of the ride system 100 in a third operating state. As shown, the ride-accessing person 202 has moved out of the unsafe zone/space 290 and into a safe space or zone 164 associated with or in one of the machine rooms (i.e., room 160 in ride 150).

A tag reader 168 (such as an RFID reader) is provided in the safe space 164, and the reader 168 may, in part, define the safe space boundaries with its range or abilities to read (e.g., be configured or selected to only have a range and/or with directional reading limited to the safe space 164). The tag reader 168 acts to read the ID 155 (e.g., an RFID tag) and relays the read information via signal 369 to the access control module 116 and controller 110. The access control module 116 acts to determine, such as based on which tag readers 152 or 168 are providing the ID data 155, 157, 159, the current locations 134 of each control key 130 matching the ID information in the signals/communications 153, 369.

Hence, the module 116 is able to determine that the key 154 is now in the safe space 164 associated with machine room 160 while keys 156, 158 remain in the control space (another safe space in ride 150). This location information is provided to the ride program 113, which may automatically retrieve another set of ride operating parameters as defined in a file/record 144 that is linked to or matches the set of current locations, and control signals 118B are sent to the machine(s) 162B that operates in a third operating state (e.g., a first maintenance/testing state suited for the current key locations in ride 150). The ride 150 is shown to operate in a second access control mode, which may involve operating all the machines in normal operating states except for those in the machine room 160 in which the person 202 and key 154 is located or otherwise operating in a state that is safe but yet facilitates effective maintenance and/or testing of the ride 150.

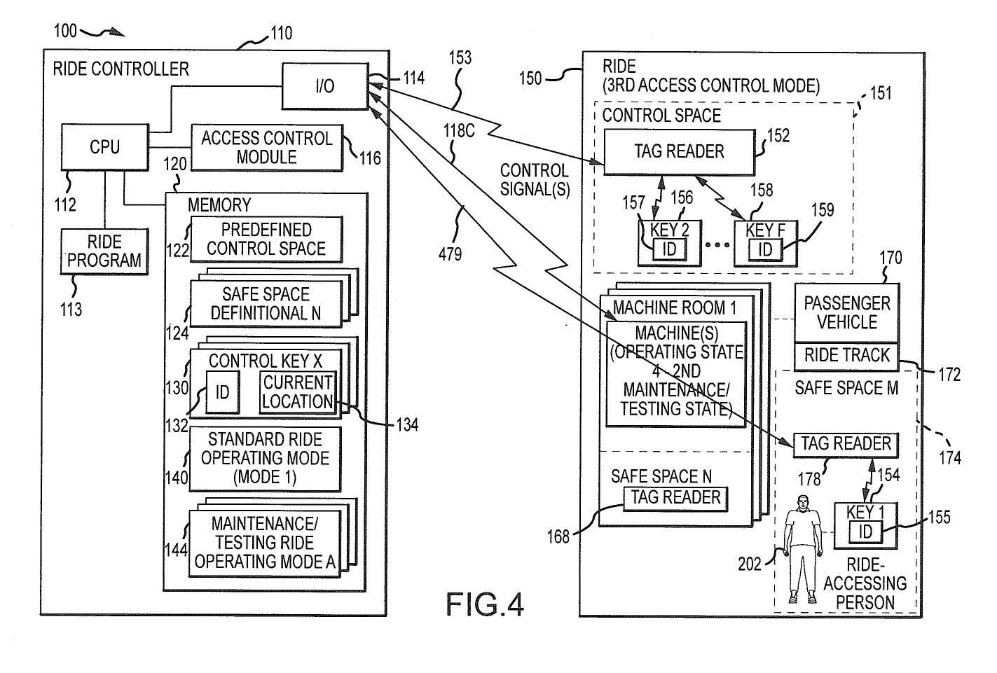

Further, in some embodiments as shown in FIG. 4, the ride-accessing person 202 may leave the safe space 164 and move into another safe space 174 associated with a location/area where operation and movement of a passenger vehicle 170 over a stretch or length of track 172 can be effectively monitored. For example, a test ride may be configured such that the vehicle 170 is driven through one or more stretches of a ride track 172 and the space 174 may be an area where these sections can be watched without risk of injuring a person 202 in the space 174. Again, a tag reader 178 is provided in or near the safe space 174 and functions to read the key 154 (e.g., an RFID reader acts to read an RFID tag 155 with identification data for key 154). The read data is transmitted to the access control module 116 via signals/communications 479.

The access control module 116 again determines the current locations 134 of each key 130 such as by matching which reader 152, 168, or 178 transmitted the ID data that matches the ID 132 stored in record/file 130 in memory 120. The access control module 116 determines first that each key 154, 156, 158 is in one of the predefined safe areas/zones assigned to the ride 150 and second which safe areas are occupied. This information is communicated to the ride program 113, which acts to retrieve the ride operating mode 140, 144 matching the subset of safe spaces 151, 164, 174 presently occupied by access persons 202 (or containing the keys 154, 156, 158). Then, the ride program 113 sends control signals 118C to the machines 162C to cause them to operate according to operating parameters defined by the operating mode 140, 144. As shown, this may cause the machines 162C to operate in a fourth operating state and the ride 150 to be in a third access control mode.

The number of operating modes is not limiting to the invention as long as the ride 150 can be operated in at least two operating modes. The particular operating parameters also may be varied widely to suit the particular ride, the maintenance being performed, the testing being required after maintenance or during initial installation (or after a modification), and so on.

FIG. 5 illustrates an intelligent ride access control method 500 that may be implemented by operation of a ride system such as system 100 of FIGS. 1-4. The method 500 starts at 505 such as by providing a number of smart tags or access keys, such as two or more badges with RFID tags (including coded ID data) to support the number of workers that may perform testing or maintenance in a location that is remote to the control space (a space where the keys or tags may be stored during normal or non-testing/non-maintenance operations of the ride).

The method 500 continues at 510 with defining a set of safe spaces for a particular amusement park or theme ride (and storing definitions in memory accessible by a ride controller). The safe spaces typically will include a control space or key storage space for storing keys during normal operations. Further, a safe space may be provided or defined (where possible to support safety considerations) each machine or portion of the ride that may need to be maintained and/or observed while the ride is fully or partially operating. Step 510 may also include installing a plurality of tag readers (e.g., RFID readers) or other key recognition devices (e.g., bar code scanners or the like) in predefined/predetermined safe spaces for maintenance, testing, and other personnel. These devices preferably are able to detect the presence of control key or smart tag anywhere within the safe space, but, in some cases, the ride system will include read indication lights (or other devices such as speakers or user interface screens) that provide visual and/or audible indication that a key has been successfully detected to provide feedback to a person wearing or carrying an access key.

The method 500 continues at 520 with defining a set of operating states for a ride such as for its drive mechanisms, special effect components, and/or other “machines” (and storing machine operation parameters and other information for establishing a particular ride operating state). These operating states are each linked to or associated with a particular set of access control key locations relative to the safe spaces/zones defined in step 510. For example, a first operating state may be associated with (or require) all keys be within the control space while a second operating state (e.g., shutdown or machines disabled) may be associated with any one of the keys being in an unknown space or being outside of one of the safe spaces defined in step 510. Third and additional operating states may be associated with all the keys being in safe spaces but one or more being outside of the control space and in another safe space.

The method 500 continues at 530 with the ride controller initiating the access control operations, which preferably are at least partially automated rather than requiring manual steps (as was the case with prior techniques/access control systems). Step 530 may involve the ride controller running an access control module and the tag readers to provide tag ID information to the access control module. At step 540, the method 500 includes receiving signals/communications from the tag or key readers (or other devices used to determine locations of smart tags or access control keys), and this received data typically will include ID data but may also include position or location information.

At step 550, the access control module acts to determine the current location of each and every one of the control keys defined in step 505 as being associated with a ride. Typically, this will involve determining whether each access control key or smart tag is within a safe space for the ride or whether one or more is outside such spaces (whether in a known or unknown location). The method 500 continues at step 560 with determining whether the location of any of the keys has changed, i.e., has any key moved out of or into a safe space/zone for the ride.

If not, the method 500 continues at 540 with receiving more signals from the tag readers/device locators. If a key/tag has changed locations (as defined above), the method 500 continues at 570 with the ride controller (e.g., in response to the access control module providing locations of keys/tags in safe spaces (and which ones) or outside safe spaces) acting to select operating modes and/or operating parameter sets that are associated with or that match the current locations of the tags/keys in or relative to the ride. The method 500 may then continues at 540 with receiving more signals/communications from the tag/key readers or may end at 590.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The intelligent ride access control method (and system) described herein provide a number of useful advantages over prior manual control techniques. First, the access control method makes the ride controller (or ride system with such a ride controller) automated in its access control features such that human error is reduced (e.g., error now would be limited to a worker not removing a tag/key from the control reader space and keeping it on or near their person). Second, the access control method allows access to spaces within a machine room or near a park ride during at least some operations. This limited access during operations is based on intentional planning and assessment of potential dangers during operations, which reduces errors caused by last minute reviews and approvals or which also lessens overly restrictive requirements that could make maintenance and ride testing very costly or simply not possible.

I claim:

1. A method for controlling an amusement or theme park ride to provide safe access for maintenance and testing, comprising:
first determining a location of an access control key;
second determining whether the determined location is within a control space;
when the access control key is in the control space as indicated by the second determining, operating a machine of the park ride in a first operating mode; and
when the access control key is outside the control space as indicated by the second comparing, operating the machine of the park ride in a second operating mode differing from the first operating mode.

2. The method of claim 1, wherein the second operating mode comprises disabling operations of the machine.

3. The method of claim 2, further comprising, after the operating the machine in the second operating mode, repeating the first determining of the location of the access control key, third determining whether the determined location is within a predefined safe space in the park ride, and when the access control key is within the predefined safe space operating the machine of the park ride in a third operating mode including reconfiguring operating parameters of the machine relative to the first operating mode.

4. The method of claim 1, wherein the access control key comprises an radio-frequency identification (RFID) tag and wherein the determining of the location of the access control key comprises reading the RFID tag to retrieve an ID for the access control key with an RFID reader positioned in the control space.

5. The method of claim 4, wherein the second determining comprises identifying the RFID tag reader as one in the control space and identifying the ID as being associated with the access control key.

6. The method of claim 1, further comprising when the access control key is outside the control space, third determining whether the determined location is within a safe space defined relative to the machine.

7. The method of claim 6, wherein the first operating mode comprises operating the machine according to a first set of operating parameters and the second operating mode comprises operating the machine according to a second set of operating parameters differing at least partially from the first set of operating parameters.

8. A method for controlling personnel access during operations, comprising:
determining a current physical location of a plurality of smart tags within a ride;
when the current physical locations are all within a predefined control space for the ride, enabling operation of the ride in a first operating state;
when any one of the current physical locations is unknown or in a predefined unsafe space for the ride, disabling operation of the ride; and
when at least one of the current physical locations is within a safe space defined for the ride outside of the predefined control space, enabling operation of the ride in a second operating state.

9. The method of claim 9, wherein the smart tags comprise RFID tags and the determining includes reading the RFID tags with one or more RFID readers positioned in or proximate to the predefined control space for the ride.

10. The method of claim 9, wherein the second operating state comprises operating machines of the ride located outside of the safe space.

11. The method of claim 9, wherein the first operating state defines a first set of operating parameters for machines of the ride associated and the second operating state defines a second set of operating parameters for the machines of the ride that differ at least partially from the first set of operating parameters for the machines of the ride.

12. The method of claim 9, wherein the enabling operating of the ride in the second operating state comprises determining at least a second one of the current physical location is within a second safe space defined for the ride outside of the predefined control space.

13. The method of claim 12, wherein the second operating state includes operating parameters for one or more machines of the ride that are reconfigured relative to the operating parameters for the one or more machines of the ride as defined for the first operating state.

14. A ride control system, comprising:
a ride controller running an access control module;
a number of access control keys each coded with a readable ID;
memory accessible by the ride controller storing for each of the access control keys an ID and a current location and further storing first and second operating states defining operating parameters for machines of a ride;
a first reader, in a control space for the ride, adapted for reading the readable ID of each of the access control keys and, in response, communicating first data from the reading to the ride controller; and
a second reader, in a safe space outside the control space of the ride, adapted for reading the readable ID of the access control keys and, in response, communicating second data from the reading to the ride controller,
wherein the access control module processes the communicated first and second data to determine locations of the access control keys and, in response, to update the current location stored in the memory for each access control keys, and
wherein the ride controller operates the machines of the ride in the first operating state or the second operating state based on the updated current locations.

15. The system of claim 14, wherein the ride controller operates the machines of the ride in the second operating state when one or more of the access control keys is within the safe space.

16. The system of claim 15, wherein, when of the updated current locations is outside of both the control space and the safe space, the ride controller disables operation of at least a subset of the machines of the ride.

17. The system of claim 14, wherein the readable ID comprises an RFID tag and the first and second readers comprise RFID readers.

18. The system of claim 14, further comprising a visual or audible indicator in the safe space and wherein the ride controller operates the visual or audible indicator in response to receiving the second data from the second reader.

19. The system of claim 18, wherein the ride controller only operates the machines in the second operating state upon receipt of additional input from an operator in the second space.

20. The system of claim 14, further including a third reader, in a second safe space outside the control space and spaced apart from the safe space, adapted for reading the readable ID of the access control keys and, in response, communicating second data from the reading to the ride controller,
wherein the access control module processes the communicated third data to determine locations of the access control keys and, in response, to update the current location stored in the memory for each of the access control keys, and
wherein the ride controller operates the machines of the ride in a third operating state, differing from the first and second operating states, when the updated current locations indicates one of the access control keys is in the safe space and another one of the access control keys is in the second safe space.
